(19) United States
(12) Patent Application Publication
(10) Pub. No.: US 2016/0364613 A1
(43) Pub. Date: Dec. 15, 2016

(54) CONTROL METHOD FOR ASSOCIATING IMAGE WITH COOKING INFORMATION, COOKING EQUIPMENT, AND PROGRAM

(71) Applicant: Panasonic Intellectual Property Management Co., Ltd., Osaka (JP)

(72) Inventors: Kazuhiro KUROYAMA, Osaka (JP); Shinsuke KAWAGUCHI, Shiga (JP); Yasuo YOSHIMURA, Shiga (JP)

(21) Appl. No.: 15/175,524

(22) Filed: Jun. 7, 2016

(30) Foreign Application Priority Data
Jun. 11, 2015 (JP) 2015-117976

(51) Int. Cl. G06K 9/00; H04N 5/232

(52) U.S. Cl. CPC G06K 9/00718; H04N 5/23203; G06K 2209/17

(57) ABSTRACT

A method includes: controlling a cooking appliance for cooking; obtaining cooking information for the cooking appliance controlled in the controlling of the cooking appliance; and requesting imaging in accordance with a state of the cooking appliance. The method also includes: controlling a camera for capturing an image of food cooked by the cooking appliance in response to the request made in the requesting of the imaging; and associating the image captured in the controlling of the camera with the cooking information obtained in the obtaining of the cooking information.

### RELATED APPLICATIONS

This application claims priority under 35 U.S.C. §119 to Japanese Patent Application No. 2015-117976 filed on Jun. 11, 2015, the entire content of which is hereby incorporated by reference.

### BACKGROUND

1. Technical Field

The present invention relates to a control method, an equipment, and a program for associating an image with cooking information.

2. Description of the Related Art

In recent years, users have actively posted food the users cooked to community sites relating to food and recipes that are operated on the Internet for sharing information thereof with third persons.

Japanese Patent Unexamined Publication No. 2006-146349 has proposed cooking equipment that saves, for each home, food cooking methods and ingredients used while reflecting the methods and the ingredients to food recipes and that also shares the saved food recipes such that third persons can search for them.

### SUMMARY

In the related art, it is necessary for a user to separately perform an operation of selecting a stationary image or a moving image of food cooked and imaged by the user and an operation of inputting information (cooking information) relating to a cooking appliance such as temperature setting and cooking time which are employed in the cooking for posting the food cooked by the user to a community site, for example.

Even in a case of using cooking equipment as disclosed in Japanese Patent Unexamined Publication No. 2006-146349, it is necessary for the user to input the recipe of the food including the cooking information.

This is because even if the food is cooked by using a cooking appliance owned by the user, the completed food and the cooking information have no relation, which brings about a need of such complicated operations.

If the user desires to post a recipe of a favorite food several days after cooking the food, for example, the user may forget corresponding cooking information (for example, an output of a microwave and cooking time) or input erroneous cooking information when the user selects an image of the food to be posted from images of the food captured in advance.

Furthermore, there is a possibility that if the erroneously input cooking information is not obviously incorrect to such an extent that the setting cannot be made by the target cooking appliance, a third person cannot recognize that the cooking information is incorrect and the erroneous cooking information is continuously published.

Furthermore, there is a possibility that if identification information for identifying the cooking appliance itself that is used for the cooking is erroneously input, a viewing third person cannot recognize what kind of cooking appliance is used to cook the food.

The invention provides a control method for associating a captured image with cooking information, including: controlling a cooking appliance for cooking; obtaining cooking information for the cooking appliance controlled in the controlling of the cooking appliance; requesting imaging in accordance with a state of the cooking appliance; controlling a camera for capturing an image of food cooked by the cooking appliance in response to the request made in the requesting of the imaging; and associating the image captured in the controlling of the camera with the cooking information obtained in the obtaining of the cooking information.

Thus, it is possible to automatically associate a captured image, such as a photo or a moving image, of food with cooking information of a cooking appliance at an appropriate cooking timing for the cooking appliance. Therefore, it is possible to automatically maintain a relationship between the food and the cooking, which has not been able to be held in the related art, as a relationship between the image of the food and the cooking information.

Since the image of the food is associated with the cooking information, it is possible to extract cooking information of the cooking appliance associated with the image of the food by selecting the image of the food when the user posts the image of the food to a community site on the Internet, for example. Therefore, it is possible to post the image while automatically adding the cooking information of the cooking appliance for the food to be posted. Therefore, it is possible to easily post the cooking information of the cooking appliance and to prevent the cooking information from being erroneously described during the posting.

### BRIEF DESCRIPTION OF THE DRAWINGS

FIG. 1 is a diagram illustrating an overall configuration of cooking equipment according to a first embodiment of the invention;

FIG. 2 is a block diagram illustrating the respective configurations of the cooking equipment according to the first embodiment of the invention;

FIG. 3 is a diagram illustrating an example of a configuration of associated information handled by the cooking equipment according to the first embodiment of the invention;

FIG. 4 is a diagram illustrating an example of an imaging confirmation screen displayed on a display of the cooking equipment according to the first embodiment of the invention;

FIG. 5 is a sequence diagram of the cooking equipment according to the first embodiment of the invention;

FIG. 6 is a flow diagram in a case of determining an imaging request after completion of cooking by the cooking equipment according to the first embodiment of the invention;

FIG. 7 is a flow diagram in a case of determining the imaging request in accordance with content of cooking information handled by the cooking equipment according to the first embodiment of the invention;

FIG. 8 is a diagram illustrating an example in which an image handled by the cooking equipment according to the first embodiment of the invention is associated with identification information or the like of the cooking appliance;

FIG. 9 is a diagram illustrating an overall configuration of a cooking appliance that forms cooking equipment according to a second embodiment of the invention;

FIG. 10 is a block diagram illustrating a configuration of the cooking appliance that forms the cooking equipment according to the second embodiment of the invention;

FIG. 11 is a diagram illustrating a sequence of the cooking appliance that forms the cooking equipment according to the second embodiment of the invention;

FIG. 12 is a diagram illustrating an overall configuration of cooking equipment according to a third embodiment of the invention;

FIG. 13 is a diagram illustrating an overall configuration of cooking equipment according to a fourth embodiment of the invention;

FIG. 14 is a block diagram illustrating a configuration of the cooking equipment according to the fourth embodiment of the invention;

FIG. 15 is a diagram illustrating a sequence of the cooking equipment according to the fourth embodiment of the invention;

FIG. 16 is a diagram illustrating an example of a cooking recipe display screen of the cooking equipment according to the fourth embodiment of the invention;

FIG. 17 is a diagram illustrating an example of an imaging confirmation screen of the cooking equipment according to the fourth embodiment of the invention; and

FIG. 18 is a diagram illustrating an example of a screen of the cooking equipment after posting according to the fourth embodiment of the invention.

### DETAILED DESCRIPTION OF THE PREFERRED EMBODIMENTS

Hereinafter, description will be given of embodiments of the invention with reference to the drawings. Configurations with the same reference numerals are the same configurations in the respective drawings, and description thereof will be omitted. In addition, the invention is not limited to the embodiments.

### First Exemplary Embodiment

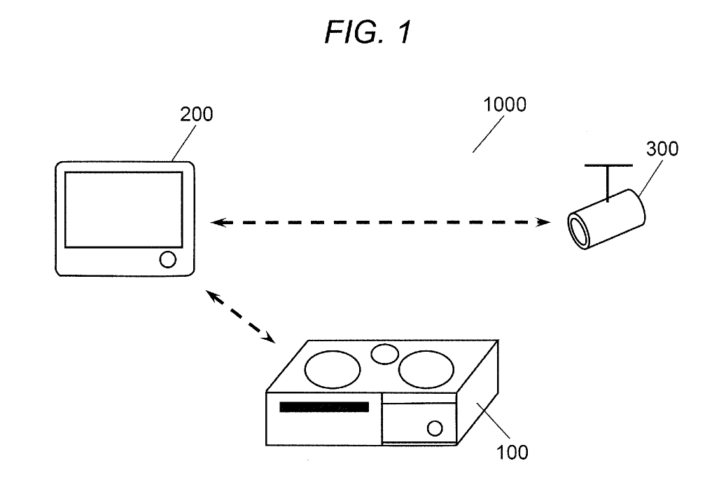

FIG. 1 is a diagram illustrating an overall configuration of cooking equipment 1000 for illustrating a method of associating cooking information according to a first embodiment of the invention.

Cooking equipment 1000 includes cooking appliance 100, information terminal 200, and camera 300.

FIG. 1 illustrates an example in which cooking appliance 100, information terminal 200, and camera 300 respectively have independent configurations. However, the invention is not limited to this example and includes a case in which the configuration of information terminal 200 is included in cooking appliance 100, a case in which the configuration of camera 300 is included in information terminal 200, and a case in which the configurations of information terminal 200 and camera 300 are included in cooking appliance 100.

Cooking appliance 100 is an appliance with a cooking function, such as a microwave, a rice cooker, an IH cooking heater, a toaster, a stove burner, a grill, an oven, a mixer, or a coffee maker.

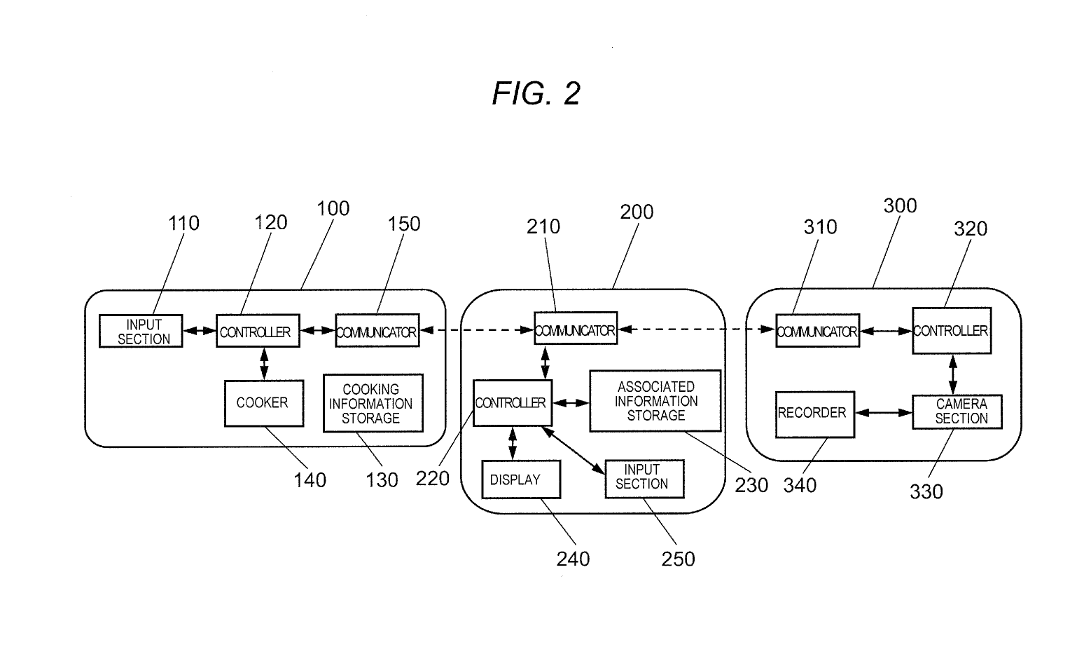

FIG. 2 is a block diagram illustrating the respective configurations of cooking appliance 100, information terminal 200, and camera 300 according to the embodiment.

First, cooking appliance 100 includes input section 110, controller 120, cooking information storage 130, cooker 140, and communicator 150.

Input section 110 is used by a user to input content of cooking for controlling cooking appliance 100, and is a dial key or a button for selecting a temperature or time for cooking, for example. Alternately, input section 110 may have a configuration for an input through a touch panel or voice.

Communicator 150, for example, instead of input section 110 can have a configuration of receiving cooking information from an external communication terminal via a network.

Here, the cooking information is content of control of the appliance used by cooking appliance 100 for cooking.

If the cooking appliance is a microwave, for example, the cooking information is information, such as a cooking method (range, oven, steam, grill, or the like), a cooking temperature, and a cooking time, to be input to the cooking appliance for cooking. If the cooking appliance is a rice cooker, the cooking information is information, such as a rice steaming course and a type of rice, to be input by the user to the cooking appliance.

A cooking number for selecting automatic cooking, which is prepared in advance in cooking appliance 100, a recipe for cooking food, information of which can be taken by cooking appliance 100 as cooking information, and the like are also included in the cooking information.

Controller 120 is formed of a microprocessor such as a Central Processing Unit (CPU) and manages control of the respective circuits such as input section 110, cooking information storage 130, cooker 140, and communicator 150.

Controller 120 controls cooker 140 of cooking appliance 100 based on the cooking information input from input section 110.

Controller 120 operates in accordance with a program stored in a Read Only Memory (ROM), for example, which is not shown in the drawing, and controls cooker 140 such as a heater based on a detection result of a sensor (not shown) for sensing a cooking state of the cooking appliance.

Cooking information storage 130 is formed of a non-volatile memory such as a flash memory and stores the cooking information and the like input through input section 110. Cooking information storage 130 may be configured to store the control program for controller 120 thereon.

Cooker 140 (cooker) is a part for performing cooking, and is a magnetron that generates a microwave if cooking appliance 100 is a microwave, for example, or is a heater for heating rice if cooking appliance 100 is a rice cooker, for example.

Communicator 150 is a part for communicating with information terminal 200 and performs communication by using infrared communication, a specified low power radio, Near Field Communication (NFC), a wireless tag, or a Radio Frequency Identification (RFID), for example. Alternatively, communicator 150 performs communication by using wireless communication such as Wireless Fidelity (Wi-Fi) (registered trademark) or Bluetooth (registered trademark). Alternatively, communicator 150 performs communication in a wired manner by using a serial cable or a Local Area Network (LAN).

Next, description will be given of information terminal 200. Information terminal 200 includes communicator 210, controller 220, associated information storage 230, display 240, and input section 250.

Communicator 210 is a part for performing communication with communicator 150 of cooking appliance 100 and performs communication based on a communication scheme corresponding to that of communicator 150.

Controller 220 is formed of a microprocessor such as a Central Processing Unit (CPU), and manages control of the respective circuits such as communicator 210, associated information storage 230, and display 240.

In addition, controller 220 associates an input through input section 250, cooking information obtained by communicator 210 from cooking appliance 100, and an image obtained from communicator 310 of camera 300, which will be described later, and stores the input, the cooking information, and the image on associated information storage 230.

Associated information storage 230 (associated information storage) associates and stores the cooking information obtained from cooking appliance 100 with the image obtained by camera 300.

Here, more specific description will be given of the information stored on associated information storage 230.

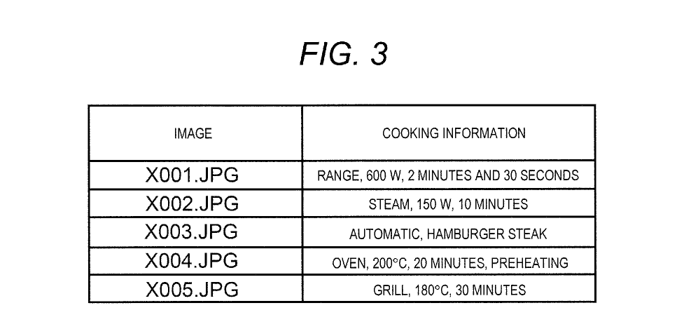

The associated information is mutually associated information such as a file name indicating an image and cooking information for controlling cooking appliance 100 as illustrated in FIG. 3, for example.

Although the file name is exemplified herein as information of the image, a configuration including information including a file path for specifying a saving position of the image file, information for identifying the camera for specifying a device of camera 300 that saves the image, information for specifying an image file, or the like is also applicable.

Alternatively, the cooking information may be stored while establishing correspondence with the image itself.

For saving the cooking information in the image itself, it is possible to record information relating to the image in an Exchangeable Image File Format (EXIF) by using the EXIF, for example as a format of the image file. Therefore, it is possible to perform the association only in image data by saving the image so as to include the cooking information.

If the cooking information is saved in the image as described above, only posting the image enables a third person who views a community site to refer to the cooking information included in the image as needed. Therefore, it becomes possible to use the image and the cooking information without caring about the association.

Even in a case of copying the same image to another site for secondary usage, it is possible to automatically copy the image along with the cooking information merely by copying the image data. Therefore, it is possible to further enhance convenience.

As a configuration of including the cooking information in the image, a format other than the EXIF may be used, or a digital watermarking technique, which has been used for copyright protection, may be used to directly embed the cooking information in the image itself.

Display 240 is a display device, such as a liquid crystal panel or an organic Electroluminescence (EL), for displaying an imaging inquiry to the user when camera 300 images food.

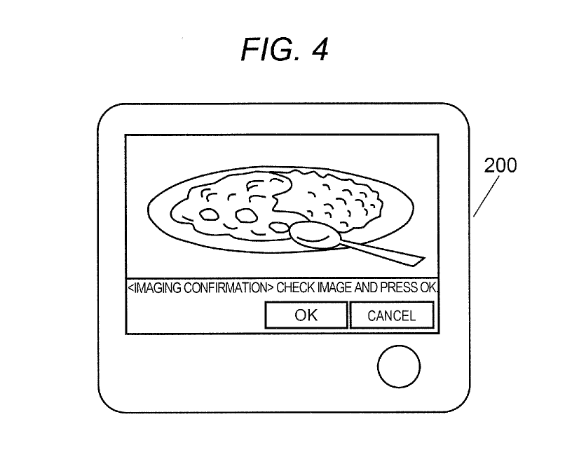

By displaying an image to be captured by camera 300 on display 240 via communicator 210 of information terminal 200 from communicator 310 of camera 300 as illustrated in FIG. 4, for example, it is possible to clearly deliver whether or not the imaging can be performed and a state of imaging to the user.

Input section 250 is used for performing an operation of responding to an imaging permission inquiry when the user images food by camera 300.

By preparing “OK” and “Cancel” as options as illustrated in FIG. 4, for example, it is possible to capture an image by selecting “OK” only when the user determines that it is necessary to capture the image.

Although description will be given on the assumption that input section 250 is incorporated as a touch panel in display 240 in the embodiment, display 240 and input section 250 may be separately formed.

Next, camera 300 includes communicator 310, controller 320, camera section 330, and recorder 340.

Communicator 310 is a part for communicating with communicator 210 of information terminal 200 and is realized by using a communication scheme corresponding to that of communicator 210.

The invention is not limited to this example, and communicator 150 of cooking appliance 100 may relay the communication by communicator 310 of camera 300. Alternatively, communicator 310 of camera 300 may relay communicator 150 of cooking appliance 100 and communicate with communicator 210 of information terminal 200.

That is, it is only necessary that communicator 150, communicator 210, and communicator 310 can communicate with each other.

Controller 320 (controlling of the camera, camera controller) is formed of a microprocessor such as a Central Processing Unit (CPU), causes communicator 310, camera section 330, and recorder 340, causes camera section 330 to capture an image in response to an imaging request sent via communicator 310, and stores the image on recorder 340.

Furthermore, controller 320 can also perform control to send information of the captured image or the image to information terminal 200 via communicator 310.

Camera section 330 (camera) is a camera for capturing an image such as a stationary image or a moving image. Camera section 330 captures a stationary image or a moving image at an imaging timing and stores the image on recorder 340 in response to the control by controller 320. Camera section 330 may store the image on associated information storage 230 of information terminal 200, for example, instead of recorder 340 via communicator 310.

Recorder 340 (recorder) stores the stationary image or the moving image captured by camera section 330.

It is possible to maintain the image even if a power supply is discontinued, by storing the image in a non-volatile memory such as an SD card (registered trademark). As for the image captured by the camera, a stationary image can be easily posted to a community site or the like, and a moving image can realistically deliver how the food is cooked to a third person when the person views the image.

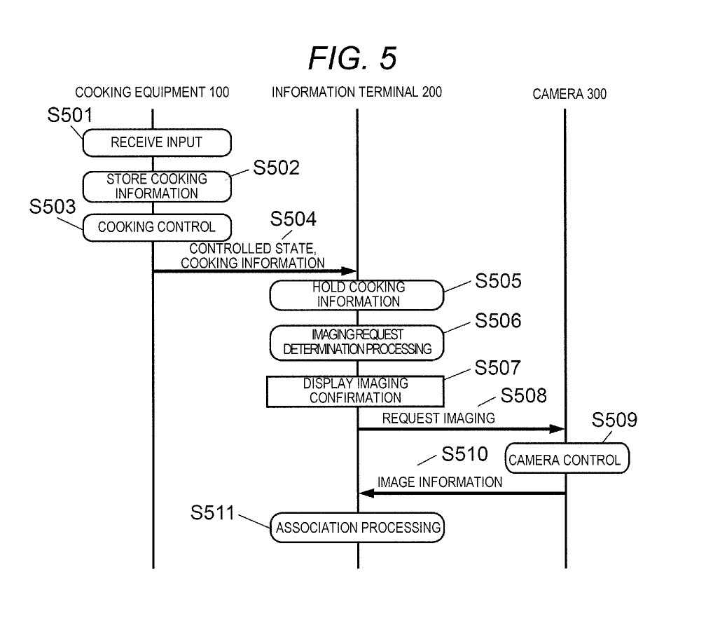

Next, description will be given of operations of cooking equipment 1000 according to the embodiment. FIG. 5 illustrates a communication sequence of cooking equipment 1000 according to the embodiment.

First, input section 110 of cooking appliance 100 receives an input as cooking information for cooking food with cooking appliance 100 from a user (Step S501).

If the cooking appliance is a microwave, for example, information necessary for cooking the food, such as a cooking method (range, oven, steam, grill, or the like), a cooking temperature, and a cooking time, is input through input section 110.

Here, the cooking information may be input directly, or information that can be converted into cooking information for controlling cooker 140 of cooking appliance 100, such as a cooking number as a base of the cooking information, may be input.

Controller 120 stores the cooking information based on the information input through input section 110 on cooking information storage 130 (Step S502 corresponding to the obtaining of the cooking information).

Controller 120 controls cooking by cooker 140 based on the cooking information (Step S503 corresponding to the controlling of the cooking appliance).

Furthermore, controller 120 delivers the controlled state of cooking appliance 100 and the cooking information to communicator 210 of information terminal 200 via communicator 150 (Step S504).

Here, the controlled state of cooking appliance 100 includes starting of cooking, a state where cooking is being currently performed, completion of cooking, cooking time, remaining cooking time, and sensor values about a temperature and the like and is information for delivering the appliance controlled state of cooking appliance 100.

Controller 220 holds the cooking information obtained via communicator 210 in associated information storage 230 for association (Step S505).

Although the example in which the cooking information is directly stored on associated information storage 230 is described in the embodiment, it is also possible to reduce the amount of associated information by holding an identification number for recognizing the cooking information as the information of cooking appliance 100 in cooking appliance 100 and information terminal 200, respectively, and storing the identification number on associated information storage 230.

Next, controller 220 determines an imaging request for instructing a timing when the image is to be captured, in accordance with the controlled state of controller 120 of cooking appliance 100 obtained via communicator 210 or the state of the cooking appliance from the cooking information (Step S506).

Here, as the state of the cooking appliance, it is possible to recognize timing when control is switched from steaming to range heating, or a user operation of opening or closing a door of cooking appliance 100, at the time of starting the cooking, at the time of completing the cooking, or during the course of the cooking, for example, in the case of a microwave, by using the controlled state of controller 120.

As the state of cooking appliance 100, it is possible to provide a request in accordance with the cooking information, such as a request for capturing images at an equal interval by equally dividing time required for cooking into ten periods by using the cooking information.

Alternatively, in a case of automatic cooking of food, such as a hamburger steak or a cake, which can be recognized through the cooking information, it is possible to provide a request in accordance with the food by incorporating the imaging request timing for each recipe of the automatic cooking in advance in cooking appliance 100.

In the case of a cake, for example, it is possible to provide the imaging request one hour after the completion of the cooking by predicting an appropriate timing when the user captures the image in consideration of a finishing process after releasing heat from the baked cake based on the content of cooking.

As for the imaging request timing, providing imaging requests at a timing when the state of the food is expected to change, such as a state during the cooking and a finished state, enables the user to conveniently use the images for posting by viewing the captured images of the food later.

In the case of capturing a moving image, it is possible to record content during the cooking by providing an imaging start request before starting the cooking and providing an imaging stop request after completing the cooking. Furthermore, inserting chapters into the moving image at a timing of user operations performed on cooking appliance 100 during the cooking, for example, at a timing of the imaging requests enables such switching of scenes that a third person can easily recognize the timing of changes when the moving image is shared with the third person. Therefore, it is possible to obtain an image that can be easily viewed.

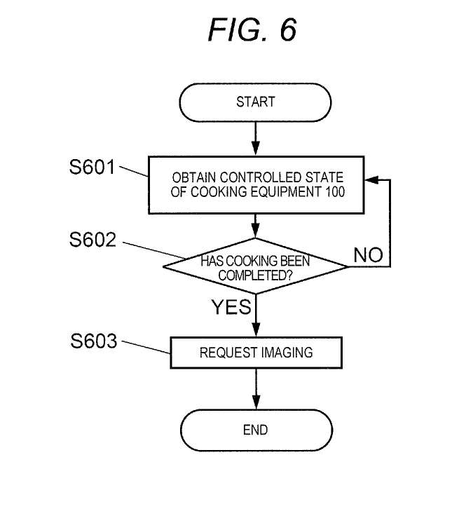

Here, description will be given of a flow of determining an imaging request at the cooking completion timing with reference to FIG. 6, as an example of an operation flow in Step S506.

Controller 220 obtains the controlled state transmitted by controller 120 of cooking appliance 100 via communicator 210 (Step S601).

Next, controller 220 determines whether cooking appliance 100 has completed the cooking based on the obtained controlled state (Step S602).

If the controlled state has changed from “during operation” to “stop”, for example, it is possible to determine that the cooking has been completed. Alternatively, with a configuration in which controller 120 of cooking appliance 100 transmits signal information indicating completion of the cooking, it is possible to determine that the cooking has been completed by obtaining the signal information indicating the completion of the cooking.

If it is determined that the cooking has been completed, controller 220 determines an imaging request (Step S603).

With such an operation flow, it is possible to determine the imaging after the completion of the cooking. Since there is a high possibility that the food is in a fresh state at the timing after the completion of the cooking, it is possible to save the image as a more effective image at this timing.

It is possible not to image the food that has not been completed by determining the imaging only when the cooking has been completed normally and determining not to perform the imaging when the cooking by cooking appliance 100 is stopped or canceled, for example, in the course thereof.

Whether the cooking has been completed normally can be determined by obtaining information about cancellation of control from controller 120 or by handling a case where an operation is stopped in a shorter period than a scheduled period in the cooking information as cancellation.

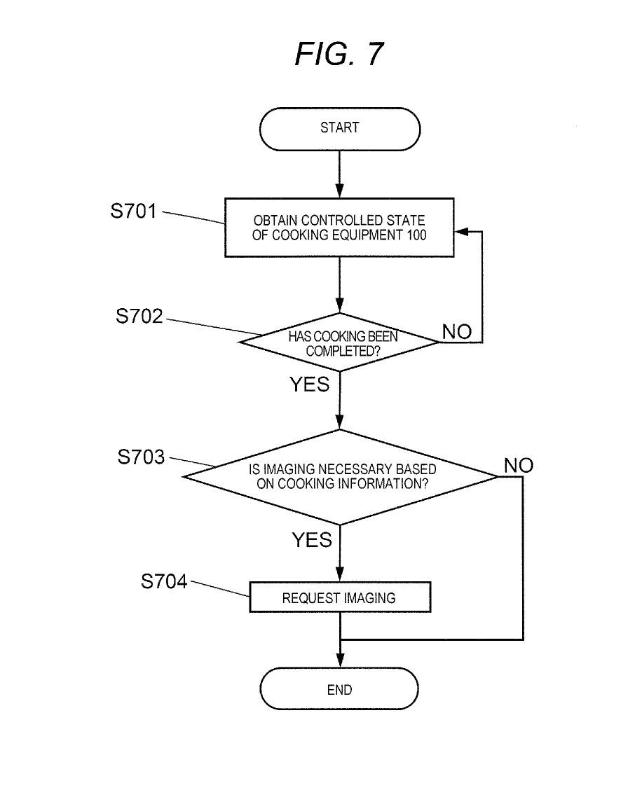

Next, description will be given of a flow of determining an imaging request depending on content of the cooking information with reference to FIG. 7, as another example of the operation flow in Step S506.

In Step S701, controller 220 obtains the controlled state transmitted by controller 120 of cooking appliance 100 via communicator 210 in the same manner as in Step S601 (Step S701).

Next, in Step S702, controller 220 determines whether or not cooking appliance 100 has completed the cooking based on the obtained controlled state in the same manner as in Step S602 (Step S702).

If it is determined that the cooking has been completed, controller 220 further determines whether or not it is necessary to capture an image based on the cooking information (Step S703). If cooking appliance 100 is a microwave, and the cooking information indicates “reheating”, for example, it is possible to determine that food that has already been cooked is being reheated, and it is thus determined that the imaging request is not to be made.

If the cooking information indicates an automatically cooked “hamburger steak”, it is possible to determine that the cooking appliance is cooking the hamburger steak, and it is thus determined that the imaging request is to be made (Step S704).

With such an operation flow, it is possible to determine imaging depending on content of the cooking information. It is possible to avoid imaging the same food several times by not capturing an image if the food is just reheated based on the cooking information.

Returning to the operation flow in FIG. 5, the description will be continued. If it is determined that an image is to be captured in the imaging request determination processing in Step S506, controller 220 causes display 240 and input section 250 to display imaging confirmation (Step S507).

As illustrated in FIG. 3, for example, an input response of “OK” or “cancel” through input section 250 is waited for by obtaining an image from camera section 330 of camera 300 via communicator 210 and providing an inquiry about whether or not an imaging can be performed while displaying the image from camera section 330 on display 240. If the response is “OK”, the processing moves on to Step S508, and an imaging request is transmitted to camera 300. If the response is “cancel”, it is determined that no association is performed, and the operation flow is stopped.

Although the operation flow is described as a flow in which the user is asked before imaging in the embodiment, it is possible to omit time and effort for the user confirmation with a configuration of automatically capturing an image by camera 300 without the user confirmation in a case of a cooking appliance, such as a microwave, in which a position of a completed food is fixed.

Controller 220 transmits imaging request information to camera 300 via communicator 210 (imaging requesting step) (Step S508).

The imaging request information is control information that is determined in advance as a protocol of camera 300 for causing camera 300 to capture an image.

Controller 320 of camera 300 receives the imaging request from information terminal 200 via communicator 310, causes camera section 330 to capture an image, and records the image in recorder 340 (Step S509).

After camera 300 captures the image, controller 320 transmits information of the image to information terminal 200 via communicator 310 (Step S510).

Controller 220 of information terminal 200 receives the information of the image from communicator 210 and associates the information with the cooking information saved in advance in associated information storage 230 in Step S505 (Step S511).

It is possible to associate the image and the cooking information by storing the image and the cooking information as a pair as illustrated in FIG. 3, for example.

With such an operation flow, it is possible to automatically associate the image, such as a photo or a moving image, of the food captured by camera 300 with the cooking information of cooking appliance 100 at the appropriate timing of cooking by cooking appliance 100 and to thereby automatically hold a relationship between the food and the cooking, which has not to be able to be held in the related art, as a relationship between the image and the cooking information of the food.

The following can be achieved when an image of food is posted to a community site on the Internet, for example, since the image of the food is associated with the cooking information. That is, it is possible to extract cooking information of cooking appliance 100, which has been associated with an image of food, by selecting an image of the food cooked in the past which is stored on associated information storage 230 and to thereby post the image of the food to be posted while automatically adding the cooking information.

Therefore, a user can easily post the cooking information of cooking appliance 100 when posting the image and can be prevented from erroneously describing the cooking information during the posting. Although the operations until the cooking information and the image were associated were described in the operation flow, it is also possible to subsequently and automatically connect to the Internet via communicator 210 of information terminal 200 and to post the image and the cooking information to a posting site registered in advance.

Controller 120 of cooking appliance 100 further records identification information for identifying cooking appliance 100 in advance in a memory that forms a program operated by controller 120, for example. In doing so, controller 120 transmits the identification information along with the control information and the cooking information to information terminal 200 in Step S504 (obtaining the identification information).

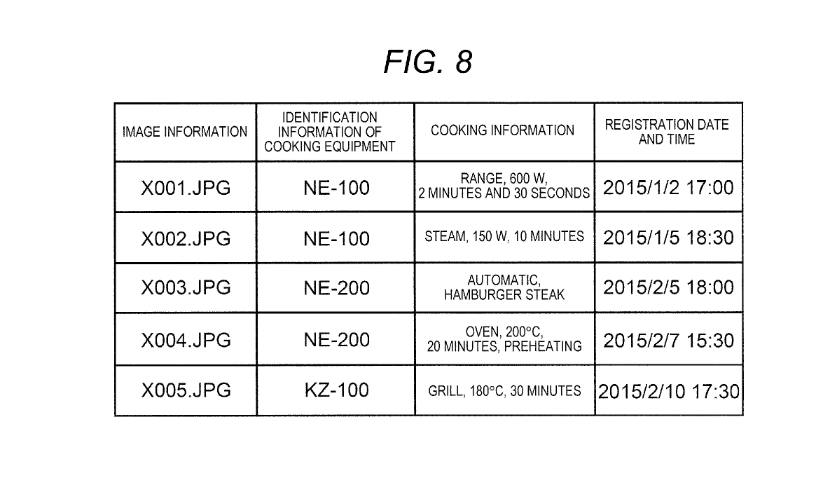

It is possible to store the identification information of cooking appliance 100 so as to associate the identification information with an image of food as illustrated in FIG. 8 by storing the identification information along with the cooking information on associated information storage 230 of information terminal 200 in Step S505.

With such an operation flow, it is possible to associate identification information for identifying cooking appliance 100 owned by the user (a model name, a model number, a product number, a name, or the like of the cooking appliance, for example) with the image of the food and the cooking information by obtaining the identification information and storing the identification information as associated information.

Therefore, it is possible to extract the cooking information of cooking appliance 100 and the identification information of the cooking appliance associated with the image of the food merely by selecting the image of the food and to automatically input the model number of cooking appliance 100, the cooking information, and the like when the image of the food is posted to a community site on the Internet, for example.

Therefore, it is possible to deliver the model number of the cooking appliance used by the user for cooking the food in the image to a third person without causing any errors.

In addition, a configuration in which date and time or identification information for identifying camera 300 is similarly associated with the image of the food facilitates more convenient usage in searching for the image of the food or posting the image of the food to a community site.

### Second Exemplary Embodiment

Next, description will be given of cooking equipment according to a second embodiment of the invention.

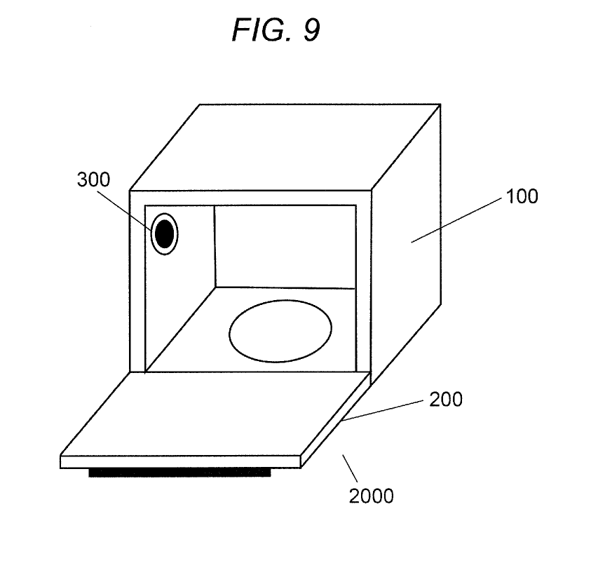

FIG. 9 is a diagram illustrating an overall configuration of cooking equipment 2000 for illustrating a method of associating cooking information according to the second embodiment of the invention. Cooking equipment 2000 has a configuration in which cooking appliance 100, information terminal 200, and camera 300 are integrated.

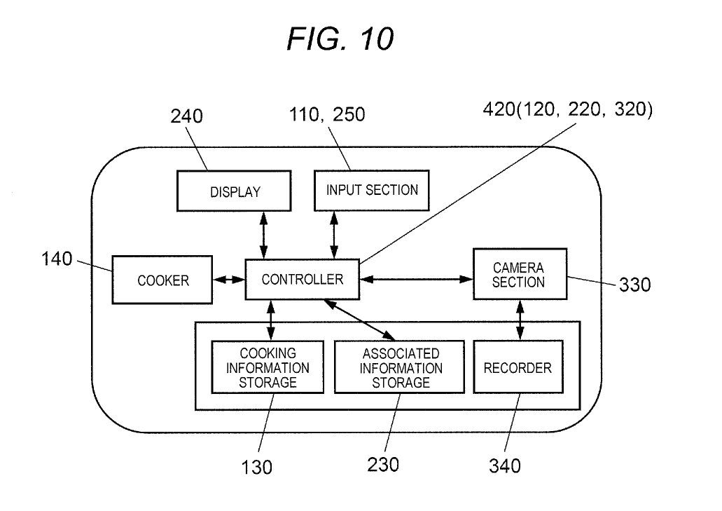

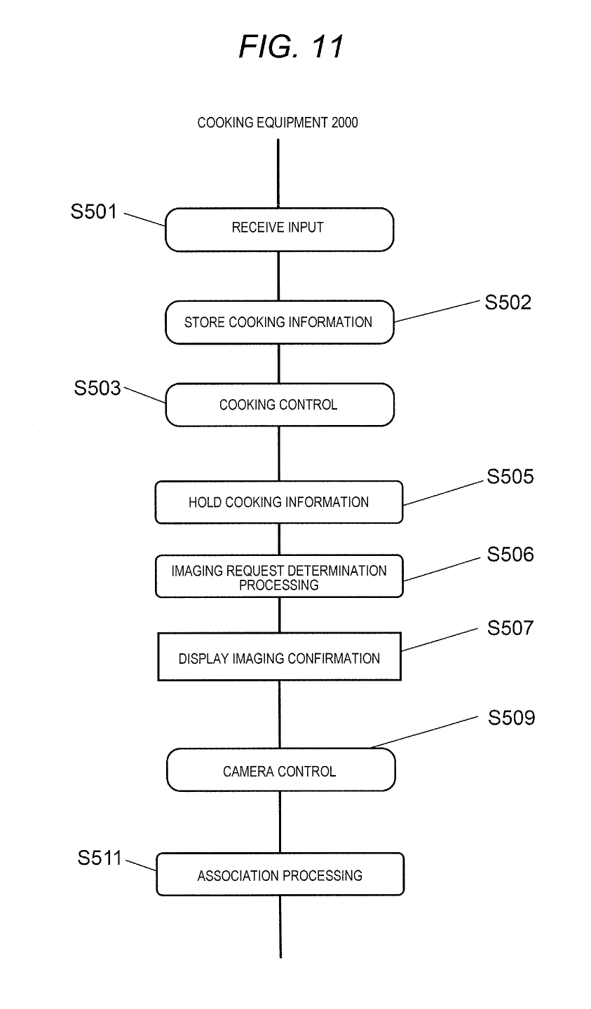

FIG. 10 is a block diagram illustrating a configuration of cooking equipment 2000 according to the embodiment. FIG. 11 is a diagram illustrating a sequence of cooking equipment 2000 according to the embodiment.

Cooking equipment 2000 includes the configurations of cooking appliance 100, information terminal 200, and camera 300 of cooking equipment 1000 according to the first embodiment, and the configurations with the same reference numerals are the same.

Each configuration with a plurality of reference numerals in a parenthesis in FIG. 10 is a single integrated configuration, which was divided into a plurality of configurations in cooking equipment 1000. For example, controller 420 has functions of controller 120, controller 220, and controller 320 illustrated in FIG. 2.

As for the operation flow, exchanging information between the respective communicators is performed in controller 420 as illustrated in FIG. 11, and other parts of the flow can be the same.

Although cooking information storage 130 and associated information storage 230 respectively store the cooking information in the embodiment, associated information storage 230 may include cooking information storage 130 to save a memory for storage.

With such a configuration, it is possible to directly exchange the controlled state, the cooking information, the identification information, and the information of the image or the image within cooking equipment 2000, to obtain a simple configuration by providing a single controller and omitting the communicators, and to thereby provide the cooking equipment at low cost. It is only necessary for the user to purchase cooking equipment 2000, and cooking equipment 2000 can be an apparatus that is more easily introduced.

### Third Exemplary Embodiment

Next, description will be given of cooking equipment according to a third embodiment of the invention.

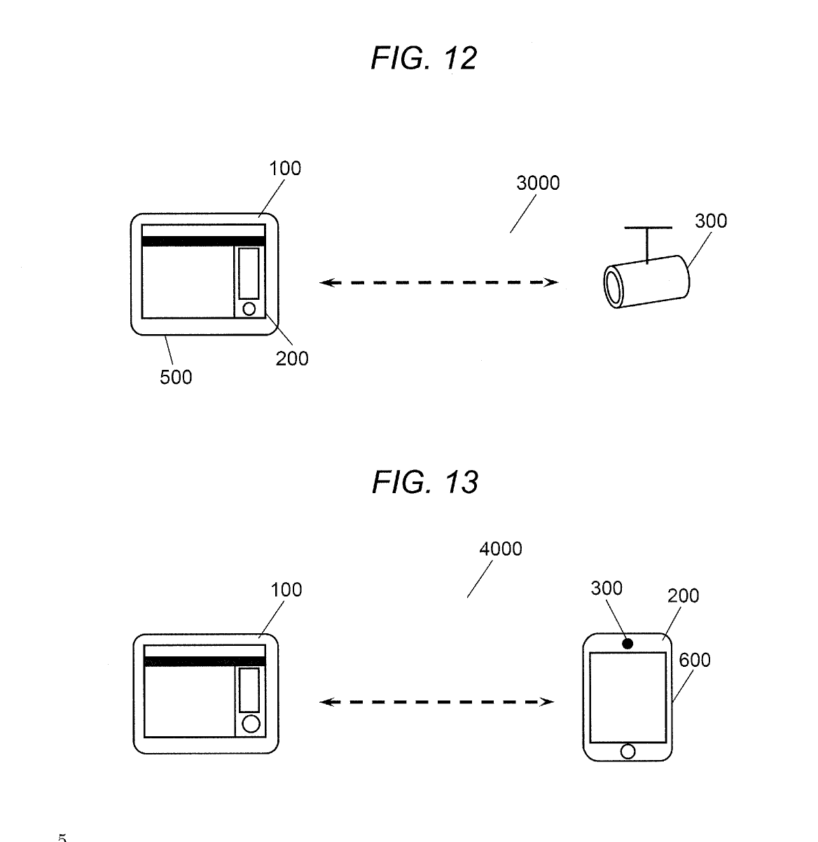

As illustrated in FIG. 12, the same effect as those of the first embodiment and the second embodiment of associating an image of food with cooking information can be achieved by forming cooking equipment 3000 so as to include device 500 as a combination of cooking appliance 100 and information terminal 200 and camera 300.

### Fourth Exemplary Embodiment

Next, description will be given of cooking equipment according to a fourth embodiment of the invention.

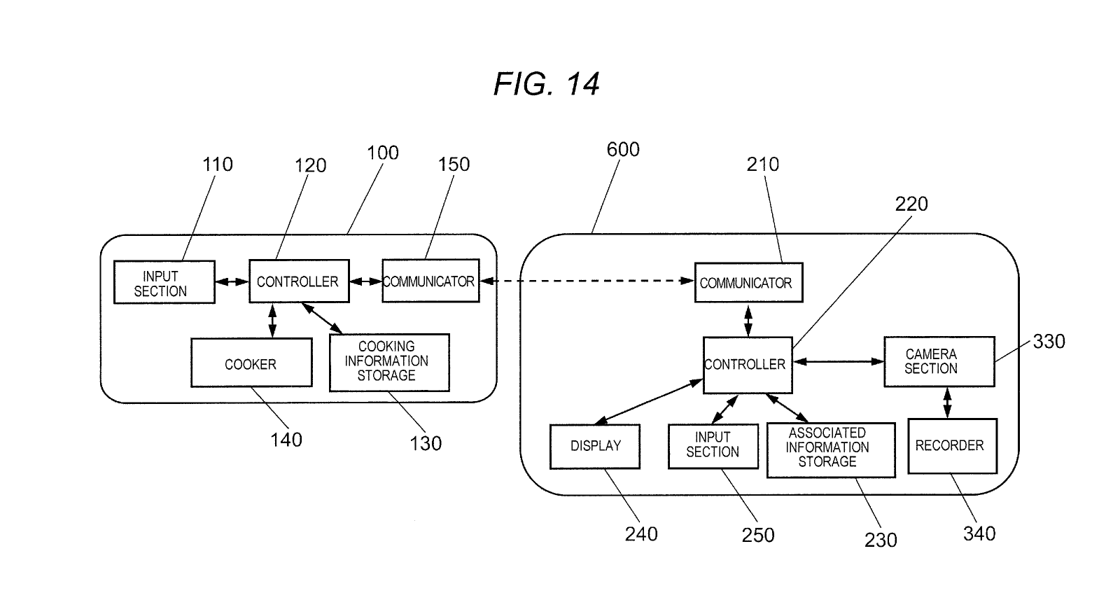

As illustrated in FIG. 13, the same effect of associating an image of food and cooking information can be achieved by forming cooking equipment 4000 so as to include information terminal 600 as a combination of information terminal 200, such as a mobile terminal provided with a camera, and camera 300 and cooking appliance 100.

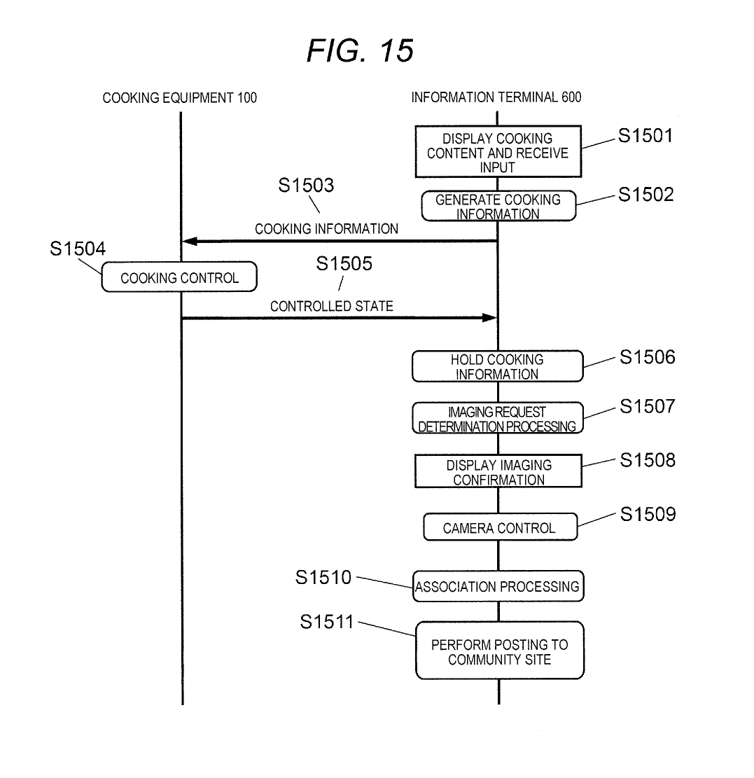

Here, a flow in which a user selects a recipe displayed in the information terminal, captures an image after cooking, associating the image with cooking information, and posting the image and the cooking information to a community site will be shown with reference to the block diagram in FIG. 14 and the sequence diagram in FIG. 15 as an example of an operation flow in the case of the configuration including cooking appliance 100 and information terminal 600 as illustrated in FIG. 13.

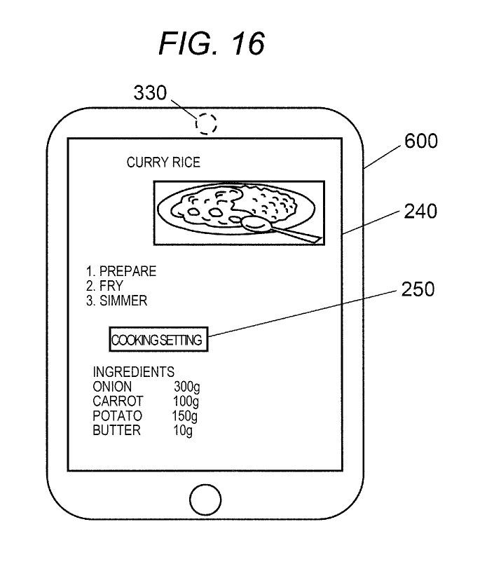

Information terminal 600 illustrated in FIG. 16 receives an input of cooking setting for causing display 240 to display the recipe as content of the cooking and for causing input section 250 to control cooking appliance 100 as illustrated in FIG. 15, for example (Step S1501).

If input section 250 receives the input of the cooking setting, controller 220 generates cooking information for controlling cooking appliance 100 (Step S1502).

Controller 220 transmits the generated cooking information to cooking appliance 100 via communicator 210 (Step S1503).

Controller 120 of cooking appliance 100 controls the cooking by cooker 140 based on the cooking information obtained via communicator 150 (Step S1504).

Controller 120 transmits the controlled state of cooking appliance 100 to information terminal 600 via communicator 150 (Step S1505).

Controller 220 of information terminal 600 holds the cooking information in associated information storage 230 in the same manner as in Step S505 illustrated in FIG. 5 or FIG. 11 (Step S1506).

Next, controller 220 determines an imaging request for instructing timing when an image is to be captured in accordance with the controlled state of controller 120 of cooking appliance 100, which has been obtained via communicator 210, and the state of the cooking appliance from the cooking information in the same manner as in Step S506 illustrated in FIG. 5 or FIG. 11 (Step S1507).

If it is determined that the image is to be captured in the imaging request determination processing in Step S1507, controller 220 causes display 240 and input section 250 to display imaging confirmation (Step S1508).

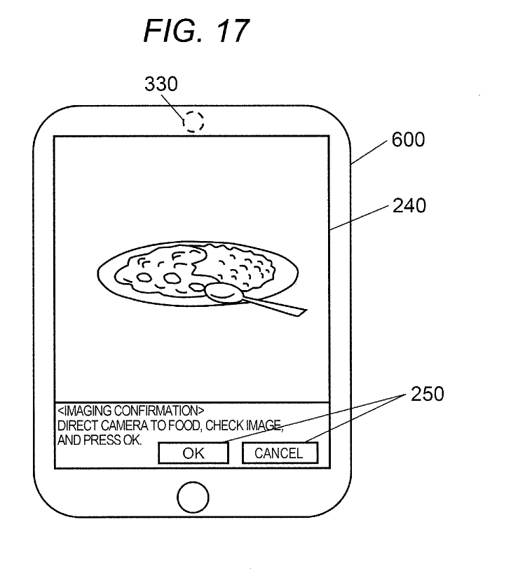

As illustrated in FIG. 17, for example, the user is encouraged to direct camera section 330 of information terminal 600 to the cooked food so as to be able to image the food.

If information terminal 200 receives an input indicating “OK” from input section 250, controller 220 causes camera section 330 to capture an image and record the image in recorder 340 (Step S1509).

Controller 220 of information terminal 200 associates the captured image with the cooking information saved in advance in associated information storage 230 in Step S1506 (Step S1510).

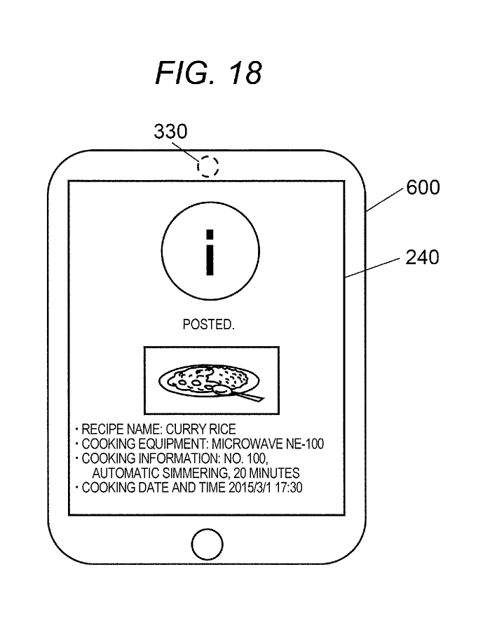

Furthermore, controller 220 of information terminal 200 automatically posts the image and the cooking information to a community site of recipes on the Internet set in advance via communicator 210 as illustrated in FIG. 18 (Step S1511).

Although various procedures for connecting to a network, such as a user ID and a password, are required to automatically post the image and the cooking information to a site on the Internet, description thereof is omitted herein on the assumption that typical communication with a site is performed.

With such a configuration, it is possible to associate the image of the food and the cooking information by using information terminal 600 with the same configuration as that of a mobile phone or a smart phone with a camera which has been widely distributed and cooking appliance 100 that can be connected to a network. Therefore, the same effect can be achieved by the user only purchasing cooking appliance 100 and using the information terminal that the user has already owned.

Next, description will be given of a control program for associating cooking information.

The control program for associating cooking information causes execution of a cooking control step for controlling the cooking appliance for cooking food and a cooking information obtaining step for obtaining the cooking information of the cooking appliance as the control setting content in the cooking control step. In addition, the control program causes execution of an imaging requesting step for requesting imaging at timing when imaging is needed in accordance with a state of the cooking appliance from the cooking control step or the cooking information and a camera control step for controlling the camera for capturing an image of the food cooked by the cooking appliance in response to the request made in the imaging requesting step. Furthermore, the control program causes execution of an association step of associating the image captured in the camera control step with the cooking information obtained in the cooking information obtaining step.

In doing so, it is possible to automatically associate a captured image, such as a photo or a moving image, of the food with the cooking information of the cooking appliance at appropriate timing of the cooking by the cooking appliance by causing the control program to operate.

For example, it is possible to extract cooking information of the cooking appliance, which has been associated with an image of food, only by selecting the image of the food and to automatically post the cooking information of the cooking appliance for the food to be posted when the user posts the image of the food to a community site on the Internet.

Therefore, the user can easily post the cooking information of the cooking appliance merely by selecting an image of food cooked in the past when the user posts the image and can be prevented from erroneously describe the cooking information during the posting. By updating the control program, it is possible to change a configuration so as to automatically perform posting to a site in accordance with a service of the community site.

The configurations specifically disclosed in the respective embodiments are only for clarifying content of the technology of the invention, and the invention should not be interrupted in a limited sense while limiting the invention only to the specific configurations described hitherto. The invention can be performed with various modifications within a spirit of the invention and a scope disclosed in claims described below.

As described above, the invention provides a control method for associating a captured image with cooking information, including: a cooking control step for controlling a cooking appliance for cooking; and a cooking information obtaining step for obtaining cooking information for the cooking appliance controlled in the controlling of the cooking appliance. The invention also includes: an imaging requesting step for requesting imaging in accordance with a state of the cooking appliance; and a camera control step for controlling a camera for capturing an image of food cooked by the cooking appliance in response to the request made in the imaging requesting step. The invention further includes: an association step for associating the image captured in the camera control step with the cooking information obtained in the cooking information obtaining step.

Thus, it is possible to automatically associate the captured image, such as a photo or a moving image, of the food with the cooking information of the cooking appliance at appropriate timing of the cooking by the cooking appliance and to thereby automatically hold a relationship between the food and the cooking, which has not been held in the related art, as a relationship between the image of the food and the cooking information.

Since the image of the food is associated with the cooking information, it is possible to extract cooking information of the cooking appliance associated with the image of the food by selecting the image of the food when the user posts the image of the food to a community site on the Internet, for example. Therefore, it is possible to post the image while automatically adding the cooking information of the cooking appliance for the food to be posted.

Therefore, it is possible to easily post the cooking information of the cooking appliance and to prevent the cooking information from being erroneously described during the posting.

The invention further includes: an identification obtaining step for obtaining identification information for identifying the cooking appliance, and in the association step, the image of the food, the cooking information, and the identification information obtained in the identification information obtaining step may be associated.

Thus, it is possible to associate the identification information for identifying the cooking appliance owned by the user (a model name, a model number, a product number, a name, or the like of the cooking appliance, for example) with the image of the food and the cooking information.

Therefore, it is possible to extract the cooking information of the cooking appliance and the identification information of the cooking appliance associated with the image of the food merely by selecting the image of the food and to automatically input the identification information such as the model number of the cooking appliance, the cooking information, and the like when the image of the food is posted to a community site on the Internet, for example.

It is possible to deliver the model number of the cooking appliance used by the user for cooking the food in the image to a third person without causing any error.

According to the invention, a request may be made at timing when cooking is completed in the requesting of the imaging.

Thus, it is possible to associate the image of the food captured at timing when the cooking by the cooking appliance has been completed with the cooking information and the identification information of the cooking appliance. Therefore, associating an image of a just completed fresh food with cooking information and identification information makes it possible to easily recognize what the food is like, and it becomes possible to associate cooking information with an image of food which is selected with a high possibility for posting.

According to the invention, an imaging request may be made if the cooking is completed normally and may not made if the cooking is stopped in the imaging requesting step.

Thus, it is possible not to capture an image and not to associate the cooking information on the assumption that the cooking is discontinued if the cooking is not completed, to reduce unnecessary images and associated information, to enhance convenience for the user, and to save a memory necessary for storage.

According to the invention, an imaging request may be made if imaging is needed and may not be performed if the imaging is not needed, depending on content of the cooking information in the imaging requesting step.

Thus, it is possible not to capture an image and not to associate cooking information if imaging is not needed, to reduce unnecessary images and associated information, to enhance convenience for the user, and to save a memory necessary for storage.

The invention may further include: image confirmation step for confirming with a user whether imaging is to be performed upon imaging in the camera control step.

Thus, it is possible for the user to determine whether the food is to be recorded as an image in advance by making confirmation with the user before the imaging. It is possible to allow the user to check and adjust imaging states such as a direction and an angle of the food and brightness of the periphery before capturing an image and to thereby leave a better image for the user.

According to the invention, the association may be made such that the cooking information is included in the captured image in the associating of the image.

Thus, only directly posting the image, for example, makes it possible for a third person who views the community site to refer to the cooking information included in the image, by making association such that the cooking information is included in the captured image. Even in a case of copying the same image to another site for secondary usage, it is possible to automatically copy the image along with the cooking information merely by copying the image data. Therefore, it is possible to obtain a highly convenient food image with an added value.

The invention includes: a cooking controller that controls a cooking appliance for cooking; a cooking information storage that stores setting content of the cooking controller; and a cooker that is made to perform cooking by the cooking controller. The invention also includes: a camera controller that causes camera to capture an image of food cooked by the cooking appliance in accordance with a state of the cooking appliance from the cooking controller or the cooking information; a camera that captures the image; a recorder that stores the image captured by the camera. The invention further includes: an associated information storage that stores associated information between the image recorded in the recorder and the cooking information recorded in the cooking information storage.

Thus, it is possible to save the image of the food cooked by the cooking appliance and the cooking information while automatically associating the image with the cooking information, merely by cooking the food with the cooking appliance. Therefore, it is possible to provide a simple and convenient apparatus to the user who frequently posts images to a community site of food on the Internet.

The invention provides a program that causes a computer to associate an image with cooking information, the program causing the computer to execute: controlling a cooking appliance for cooking; and obtaining cooking information for the cooking appliance controlled in the controlling of the cooking appliance. The invention also includes: requesting imaging in accordance with a state of the cooking appliance; and controlling a camera for capturing an image of food cooked by the cooking appliance in response to the request made in the requesting of the imaging. The invention further includes: associating the image captured in the controlling of the camera with the cooking information obtained in the obtaining of the cooking information.

Thus, it is possible to save the image of the food cooked by the cooking appliance with the cooking information while automatically associating the image with the cooking information, merely by cooking the food with the cooking appliance. Therefore, it is possible to provide a simple and convenient apparatus to the user who frequently posts images to a community site of food on the Internet.

The invention is particularly useful when a captured image of food is posted to a sharing site on the Internet, for example.

What is claimed is:

1. A control method for associating a captured image with cooking information, comprising:
controlling a cooking appliance for cooking;
obtaining the cooking information for the cooking appliance controlled in the controlling of the cooking appliance;
requesting imaging in accordance with a state of the cooking appliance;
controlling a camera for capturing an image of food cooked by the cooking appliance in response to the request made in the requesting of the imaging; and
associating the image captured in the controlling of the camera with the cooking information obtained in the obtaining of the cooking information.

2. The control method for associating an image with cooking information of claim 1, further comprising:
obtaining identification information for identifying the cooking appliance,
wherein in the associating of the image, the image, the cooking information, and the identification information obtained in the obtaining of the identification information are associated.

3. The control method for associating an image with cooking information of claim 1,
wherein in the requesting of the imaging, a request is made at timing when cooking is completed.

4. The control method for associating an image with cooking information of claim 2,
wherein in the requesting of the imaging, a request is made at timing when cooking is completed.

5. The control method for associating an image with cooking information of claim 1,
wherein in the requesting of the imaging, an imaging request is made if the cooking is completed normally and is not made if the cooking is stopped.

6. The control method for associating an image with cooking information of claim 2,
wherein in the requesting of the imaging, an imaging request is made if the cooking is completed normally and is not made if the cooking is stopped.

7. The control method for associating an image with cooking information of claim 1,
wherein in the requesting of the imaging, an imaging request is made if imaging is needed and is not made if the imaging is not needed, depending on content of the cooking information.

8. The control method for associating an image with cooking information of claim 2,
wherein in the requesting of the imaging, an imaging request is made if imaging is needed and is not made if the imaging is not needed, depending on content of the cooking information.

9. The control method for associating an image with cooking information of claim 1, further comprising:
confirming with a user whether imaging is to be performed, upon imaging in the controlling of the camera.

10. The control method for associating an image with cooking information of claim 2, further comprising:
confirming with a user whether imaging is to be performed, upon imaging in the controlling of the camera.

11. The control method for associating an image with cooking information of claim 1,
wherein in the associating of the image, the association is made such that the cooking information is included in the captured image.

12. The control method for associating an image with cooking information of claim 2,
wherein in the associating of the image, the association is made such that the cooking information is included in the captured image.

13. Equipment for associating an image with cooking information, comprising:
a cooking controller that controls a cooking appliance for cooking;
a cooking information storage that stores setting content of the cooking controller;
a cooker that is made to perform cooking by the cooking controller; and
a camera controller that causes a camera to capture an image of food cooked by the cooking appliance in accordance with a state of the cooking appliance from the cooking controller or the cooking information;
the camera that captures the image;
a recorder that stores the image captured by the camera; and
an associated information storage that stores associated information between the image recorded in the recorder and the cooking information recorded in the cooking information storage.

14. A program that causes a computer to associate an image with cooking information, the program causing the computer to execute:
controlling a cooking appliance for cooking;
obtaining cooking information for the cooking appliance controlled in the controlling of the cooking appliance;
requesting imaging in accordance with a state of the cooking appliance;
controlling a camera for capturing an image of food cooked by the cooking appliance in response to the request made in the requesting of the imaging; and
associating the image captured in the controlling of the camera with the cooking information obtained in the obtaining of the cooking information.
